(19) United States
(12) Patent Application Publication
(10) Pub. No.: US 2015/0090855 A1
(43) Pub. Date: Apr. 2, 2015

(54) VEHICLE SEAT

(71) Applicants: TOYOTA BOSHOKU KABUSHIKI KAISHA, Aichi-ken (JP); SHIROKI CORPORATION, Kanagawa (JP)

(72) Inventors: Yuji ARAKAWA, Aichi-ken (JP); Naoki HAYASHI, Aichi-ken (JP)

(73) Assignees: TOYOTA BOSHOKU KABUSHIKI KAISHA, Aichi-ken (JP); SHIROKI CORPORATION, Kanagawa (JP)

(21) Appl. No.: 14/494,104

(22) Filed: Sep. 23, 2014

(30) Foreign Application Priority Data
Sep. 30, 2013 (JP) 2013-203637

(51) Int. Cl. B60N 2/08; B60N 2/07

(52) U.S. Cl. CPC B60N 2/0862; B60N 2/07
USPC 248/429

(57) ABSTRACT

A vehicle seat includes: a slide rail; and a slide lock mechanism. The slide lock mechanism includes a locking member and an operating member; the locking member includes a first biasing member that maintains the slide lock state of the locking member in an elastically biasing manner; the operating member includes a second biasing member to bias the operating member to an initial position in which an operation of the operating member is not started; a biasing force of the first biasing member is set larger than that of the second biasing member; and a clearance is set for the operating member between the initial position and an operation position in which the release control force is applied thereto against the biasing forces of the first biasing member and the second biasing member so that the slide lock state of the locking member is released.

### INCORPORATION BY REFERENCE

The disclosure of Japanese Patent Application No. 2013-203637 filed on Sep. 30, 2013 including the specification, drawings and abstract is incorporated herein by reference in its entirety.

### BACKGROUND OF THE INVENTION

1. Field of the Invention

The present invention relates to a vehicle seat.

2. Description of Related Art

Japanese Patent Application Publication No. 2005-238929 (JP 2005-238929 A) has been known as a vehicle seat including: a slide rail including a lower rail disposed on a vehicle component side such as a floor of a vehicle, and an upper rail disposed on a seat body side and supported by the lower rail so as to be movable in a sliding manner; and a slide lock mechanism capable of regulating a slide movement of the upper rail relative to the lower rail in an appropriate position. In JP 2005-238929 A, the slide of the upper rail can be locked by a locking member and the lock by the locking member is released by operating an operating member.

### SUMMARY OF THE INVENTION

However, the vehicle seat in JP 2005-238929 A has such a concern that, along with an unexpected external load such as a large load, an unintended force in a release direction of the slide lock is applied to the slide lock mechanism or the slide lock is released due to relative torsion of the slide rail. In view of this, further improvement to such a concern is expected.

The present invention provides a vehicle seat that is able to restrain unintended release of slide lock even if an unexpected external load such as a large load is applied to a slide lock mechanism and a slide rail.

A vehicle seat according to an aspect of the present invention includes: a slide rail including a lower rail disposed on a vehicle component side, and an upper rail disposed on a seat body side and supported by the lower rail so as to be movable in a sliding manner; and a slide lock mechanism that regulates a slide movement of the upper rail relative to the lower rail in an appropriate position. The slide lock mechanism includes a locking member that regulates the slide movement of the upper rail in the appropriate position as a slide lock state, and an operating member that transmits, to the locking member, a release control force to release the slide lock state of the locking member; the locking member includes a first biasing member that maintains the slide lock state of the locking member in an elastically biasing manner; the operating member includes a second biasing member to bias the operating member to an initial position in which an operation of the operating member is not started; when a biasing force of the first biasing member is compared with that of the second biasing member, the biasing force of the first biasing member is set larger than that of the second biasing member; a clearance is set for the operating member between the initial position and an operation position in which the release control force is applied thereto against the biasing forces of the first biasing member and the second biasing member so that the slide lock state of the locking member is released; the operating member includes an operation input member that inputs the release control force, and an operation output member that outputs the release control force; the second biasing member is provided between the operation input member and the operation output member so that the operation input member is connected to the operation output member so as to be movable relative to each other; the clearance is provided between the operation input member and the operation output member; and the initial position is set by retaining the clearance between the operation input member and the operation output member by the second biasing member.

According to the above aspect, the clearance is set for the operating member between the initial position and the operation position in which the release control force is applied against the biasing forces of the first biasing member and the second biasing member so that the slide lock state of the locking member is released. Accordingly, even in a case where an unexpected external load such as a large load is applied to the slide lock mechanism and the slide rail, it is possible to restrain unintended release of slide lock. Further, the operating member includes the second biasing member to bias the operating member to the initial position in which an operation of the operating member is not started. This accordingly makes it possible to stably retain the operating member in the initial position until the release control force is applied thereto.

Further, the operating member is constituted by two components: the operation input member that inputs the release control force; and the operation output member that outputs the release control force. Further, the clearance is provided between the operation input member and the operation output member. The initial position is set by retaining the clearance between the operation input member and the operation output member by the second biasing member. This attains the slide lock mechanism that more stably restrains unintended release of slide lock.

Further, in the above aspect, between the initial position and the operation position to which the operating member moves upon reception of the release control force, the following operation positions may be set: a first operation position in which the operation input member moving from the initial position within the clearance against the biasing force of the second biasing member is engaged with the operation output member; and a second operation position in which the operation input member and the operation output member moving from the first operation position in an integrated manner against the biasing force of the first biasing member release the slide lock state of the locking member. Further, the operating member may be configured such that the operation input member and the operation output member move to the second operation position against the biasing force of the first biasing member in a state where the biasing force of the second biasing member with respect to the operation input member placed in the first operation position does not increase.

According to the above configuration, it is possible to obtain a continuous operation sense of the operating member without increasing the release control force to be applied to the operating member more than required.

Further, in the above aspect, the lock member may be disposed in a space surrounded by a lower face portion of the lower rail which faces the vehicle component side, a upper face portion of the upper rail which faces the seat body side, and a pair of side face portions of the lower rail or the upper rail, and the operating member may be inserted from longitudinal ends of the lower rail and the upper rail so as to be engaged with the locking member.

According to the above configuration, the locking member is disposed in the space of the slide rail. This makes it possible to form the slide lock mechanism in a compact shape, thereby making it possible to effectively use a space around the seat body. Further, even in such a compact slide lock mechanism, it is possible to restrain unintended release of slide lock.

According to the aspect, it is possible to provide a vehicle seat that is able to restrain unintended release of slide lock even if an unexpected external load such as a large load is applied to a slide lock mechanism and a slide rail.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an entire perspective view illustrating a car seat according to an embodiment of the present invention;

FIG. 2 is an exploded perspective view illustrating a slide rail device of the car seat according to the embodiment of the present invention;

FIG. 3 is a sectional view of the slide rail device of the car seat according to the embodiment of the present invention, taken along a longitudinal direction thereof;

FIG. 4 is a partial sectional view of a part IV in FIG. 3;

FIG. 5 is a sectional view taken along a line V-V in FIG. 4;

FIG. 6 is a sectional view at a position of a line VI-VI in FIG. 4;

FIG. 7 is a sectional view at a position of a line VII-VII in FIG. 4;

FIG. 8 is a partial perspective view of the part IV in FIG. 3;

FIG. 9 is an entire perspective view of a cap attached to a front end of the slide rail device in the car seat;

FIG. 10 is a partial sectional view of a part X in FIG. 3;

FIG. 11 is an entire perspective view of a cap attached to a rear end of the slide rail device in the car seat;

FIG. 12 is a top view of the cap attached to the rear end of the slide rail device in the vehicle seat;

FIG. 13 is a front view of the cap attached to the rear end of the slide rail device in the vehicle seat;

FIG. 14 is a side view of the cap attached to the rear end of the slide rail device in the vehicle seat;

FIG. 15 is a perspective view of a disposition state of a slide lock mechanism and an operating member of the slide rail device of the vehicle seat according to the embodiment of the present invention, when viewed from above;

FIG. 16 is a perspective view of the disposition state of the slide lock mechanism and the operating member of the slide rail device of the vehicle seat according to the embodiment of the present invention, when viewed from below;

FIG. 17 is a partial sectional view of a part XVII in FIG. 3; and

FIG. 18 is a partial sectional view of a part XVIII in FIG. 3.

### DETAILED DESCRIPTION OF EMBODIMENTS

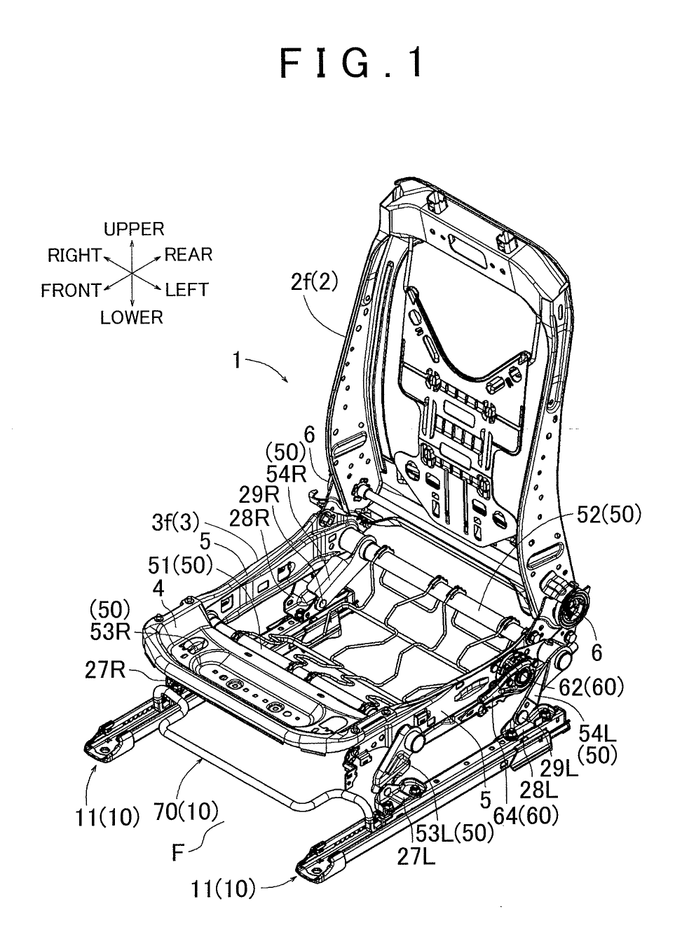

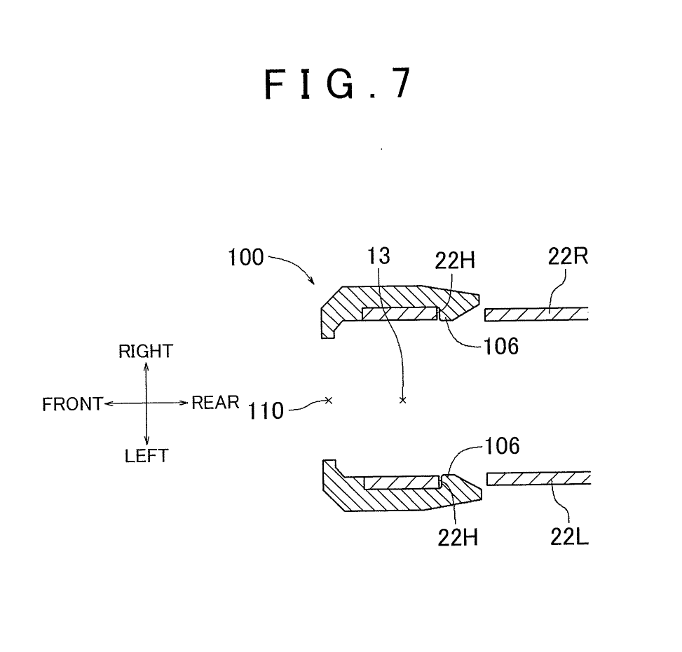

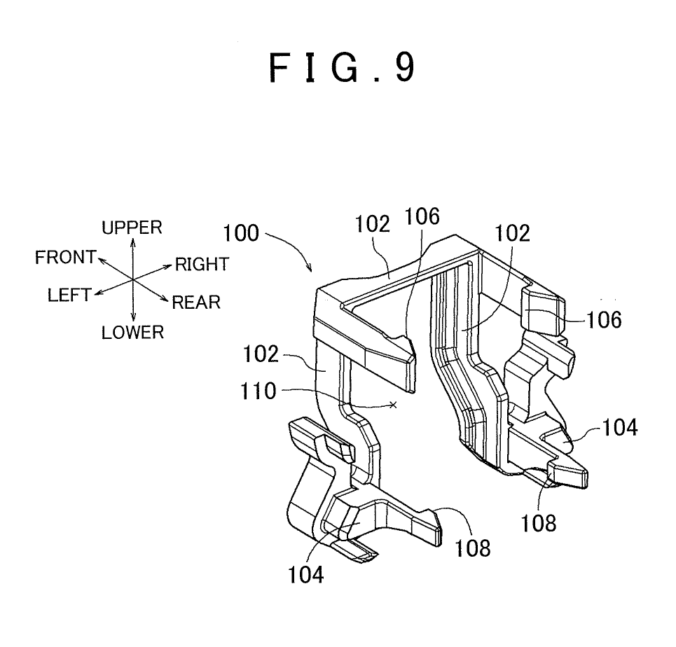

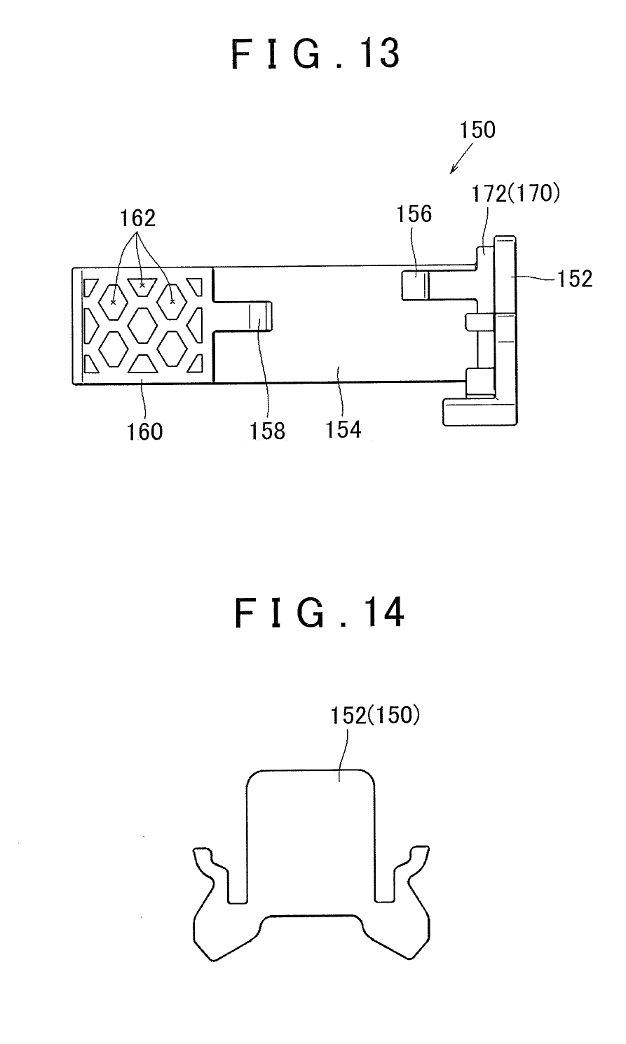

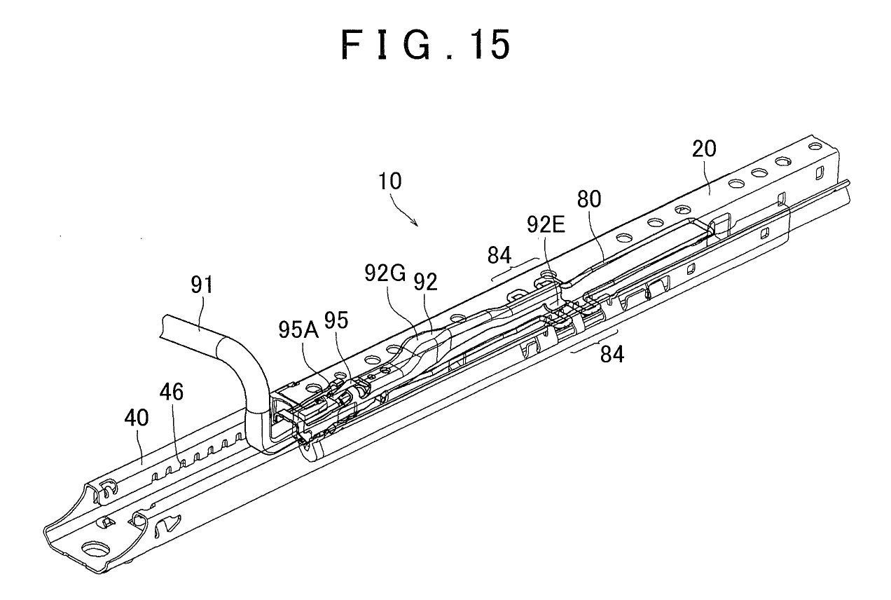

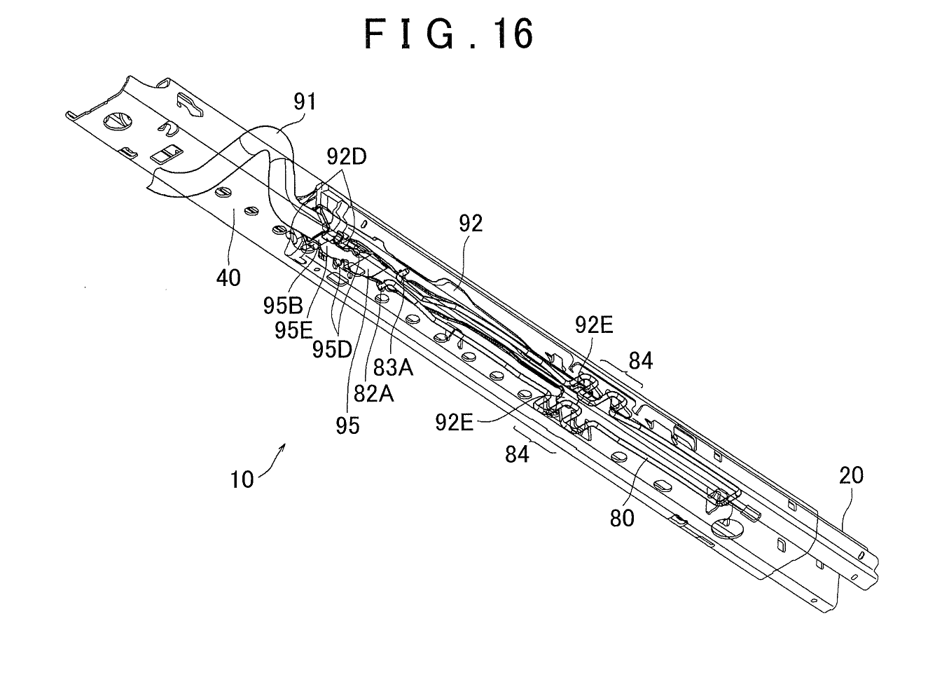

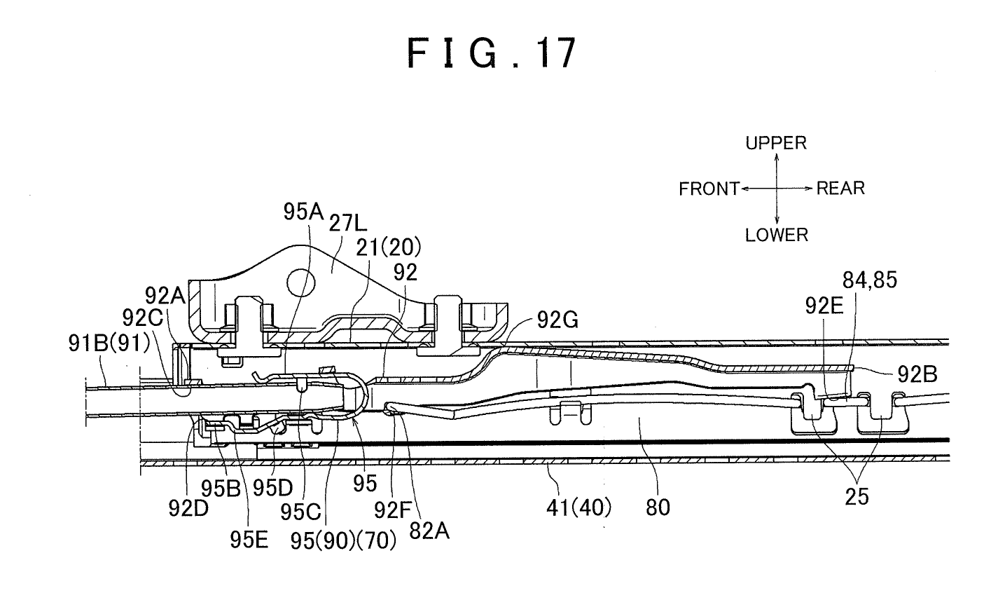

The following describes an embodiment of a vehicle seat of the present invention with reference to FIGS. 1 to 18. Note that the present embodiment deals with a front-side car seat among vehicle seats. Respective directions illustrated appropriately by arrows in each view correspond to a front side, a rear side, a top side, a bottom side, a right side, and a left side, when viewed from a sitting person sitting on a car seat employed in a vehicle and disposed toward a vehicle front side. Note that each view mainly illustrates an internal structure of a seat body so as to clearly describe a configuration of the embodiment. In view of this, in terms of a seatback 2 and a seat cushion 3, internal frame structures such as a back frame 2f and a cushion frame 3f forming a framework are mainly illustrated, and illustration and description on accessories such as an outer material and a seat pad put on an outer part of the seatback 2 and the seat cushion 3 may be omitted.

The car seat (a vehicle seat) includes a seat body 1 mainly including the seatback 2 serving as a backrest portion, and the seat cushion 3 serving as a seat portion, as illustrated in FIG. 1. The seatback 2 includes the back frame 2f forming a framework. The back frame 2f is formed in a generally rectangular frame shape by appropriately performing bending, drawing, or the like on a pipe member or a board member made of a ferrous material. The seat cushion 3 includes the cushion frame 3f forming a framework. The cushion frame 3f is formed in a generally rectangular frame shape by appropriately performing bending, drawing, or the like on a pipe member or a board member made of a ferrous material. The seat body 1 is connected to the cushion frame 3f by a reclining device 6 provided in a lower part of the back frame 2f in a width direction thereof. This allows the seatback 2 to adjust a backrest angle with respect to the seat cushion 3 and to tilt forward toward the seat cushion 3.

As illustrated in FIG. 1, the cushion frame 3f mainly includes a front frame 4, lower arms 5, 5, a front rod 51, and a rear rod 52, and is formed in a generally rectangular frame shape. The lower arms 5, 5 are formed by appropriately bending a board member having a long band-like shape. The lower arms 5, 5 are disposed on respective sides of the cushion frame 3f in its width direction on an upper side of the after-mentioned slide rail device 10, so that a longitudinal direction of the lower arms 5, 5 is along a vehicle front-rear direction. The front frame 4 is disposed on front ends of the lower arms 5, 5 so as to bridge the lower arms 5, 5, and constitutes a front end of the cushion frame 3f. The front rod 51 constituted by a pipe member made of a ferrous material is disposed on a front side of the lower arms 5, 5 so as to penetrate therethrough in the width direction to bridge the lower arms 5, 5. Similarly, the rear rod 52 constituted by a pipe member made of a ferrous material is disposed on a rear side of the lower arms 5, 5 so as to penetrate therethrough in the width direction to bridge the lower arms 5, 5. Note that the front rod 51 and the rear rod 52 are rotatable relative to the lower arms 5, 5.

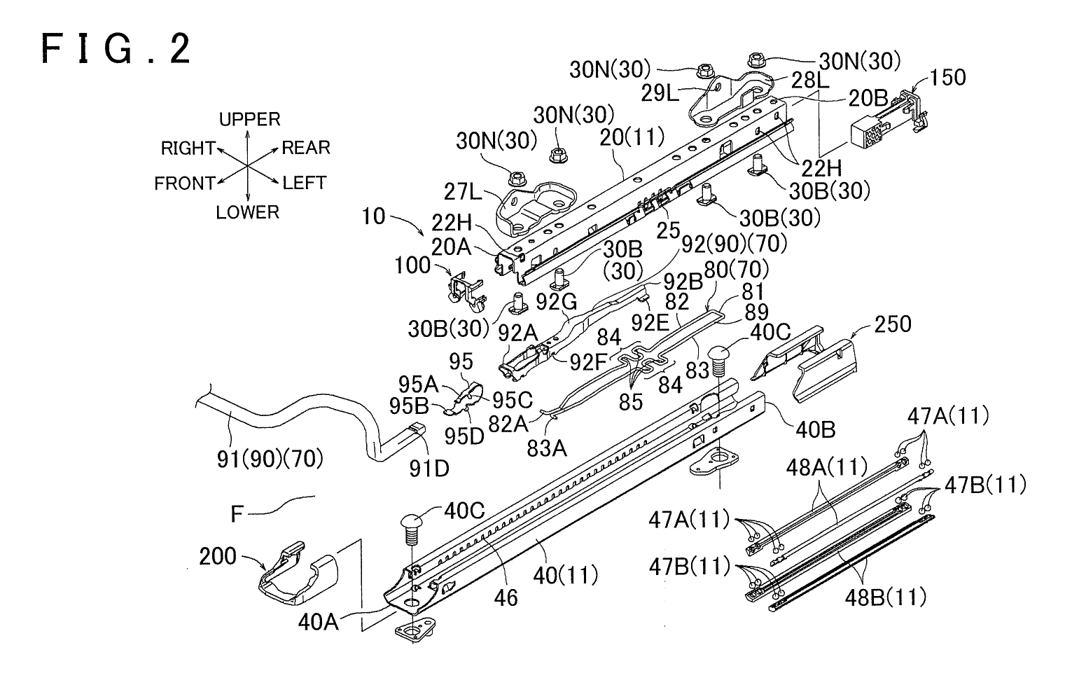

As illustrated in FIGS. 1, 2, the car seat includes a slide rail device 10 provided between the seat body 1 and a floor surface F (a vehicle component) of the vehicle and configured to adjust a sitting position of the seat body 1 relative to the floor surface F in the vehicle front-rear direction. The slide rail device 10 includes slide rails 11, 11 and a slide lock mechanism 70, as illustrated in FIG. 1. A pair of right and left slide rails 11, 11 is disposed in parallel to each other between the seat cushion 3 and the floor surface F along the vehicle front-rear direction.

As illustrated in FIG. 1, the slide rail 11 is disposed between the seat body 1 and the floor surface F of the vehicle, and serves as a mechanism to move the sitting position of the seat body 1 relative to the floor surface F in the vehicle front-rear direction. As illustrated in FIG. 2, the slide rail 11 is mainly constituted by a lower rail 40, an upper rail 20, rolling elements 47A, 47B, and guides 48A, 48B. The lower rail 40 is formed in a shape extending in the vehicle front-rear direction, and is disposed on the floor surface F. The upper rail 20 is disposed on a seat-body-1 side (see FIG. 1), and is fitted to the lower rail 40 so as to be movable in a sliding manner in a rail longitudinal direction thereof. More specifically, the lower rail 40 and the upper rail 20 are provided on top of one another via the rolling elements 47A, 47B and the guides 48A, 48B, so as to be formed in a tubular shape. Hereby, when the upper rail 20 is guided so as to be movable relative to the lower rail 40 in a sliding manner in the vehicle front-rear direction, the upper rail 20 moves the sitting position of the seat body 1 in the vehicle front-rear direction.

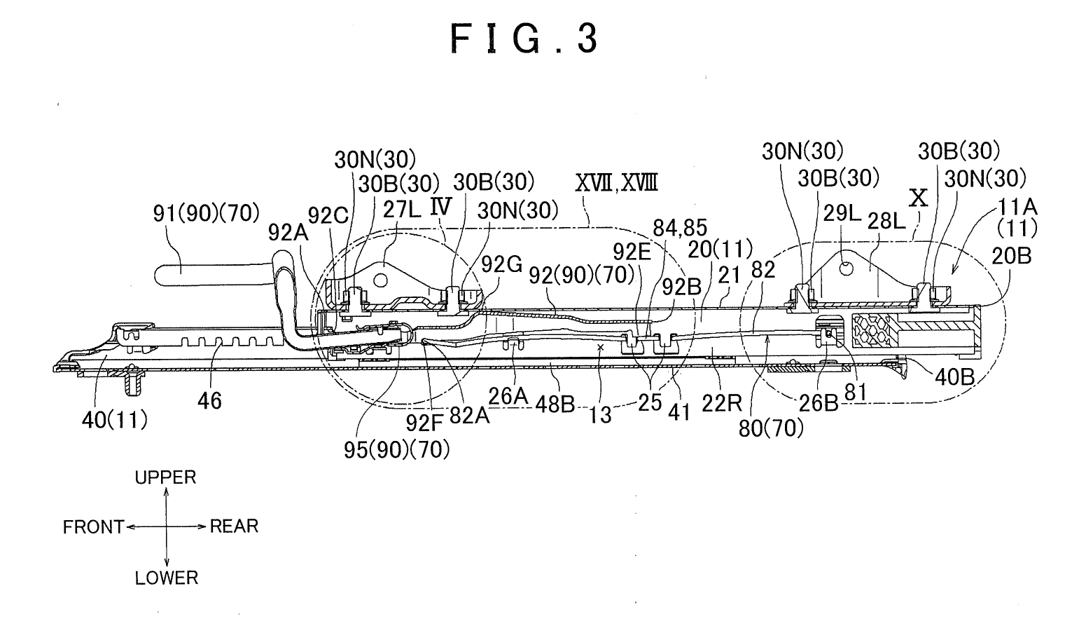

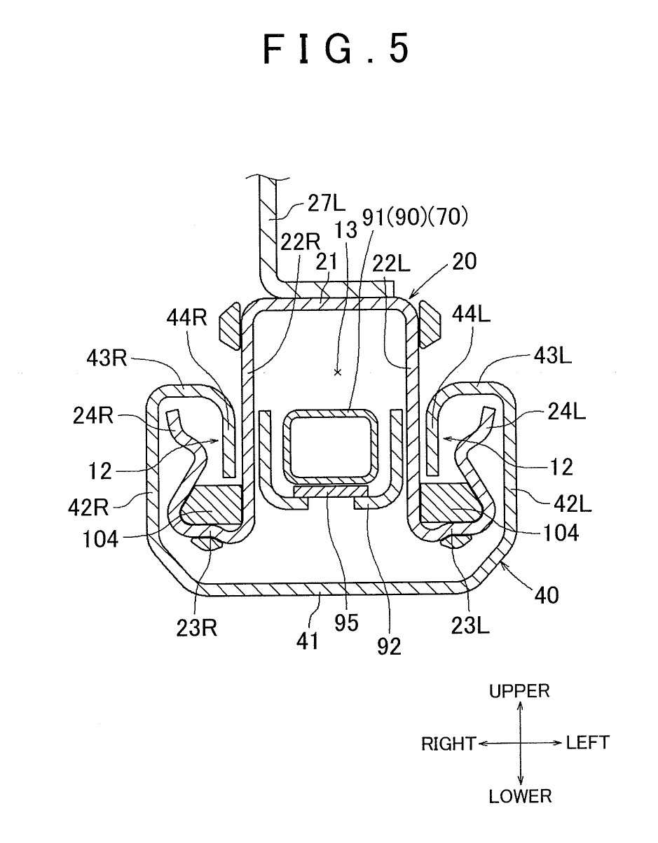

The lower rail 40 is formed in a shape extending in the vehicle front-rear direction, as illustrated in FIG. 2, and is disposed on the floor surface F. As illustrated in FIG. 5, the lower rail 40 is formed integrally to have the following cross section shape by bending, in several places, a single flat-plate member made of a ferrous material. More specifically, the lower rail 40 includes a lower face portion 41 having a flat-plate shape and facing the floor surface F (FIG. 2) generally in a parallel manner. The lower face portion 41 includes a flat-plate right side face portion 42R and a flat-plate left side face portion 42L respectively rising from both ends of the lower face portion 41. The right side face portion 42R and the left side face portion 42L respectively include a flat-plate upper right face portion 43R and a flat-plate upper left face portion 43L obtained by inwardly folding respective upper ends of the right side face portion 42R and the left side face portion 42L. The upper right face portion 43R and the upper left face portion 43L include a flat-plate right tip end portion 44R and a flat-plate left tip end portion 44L hanging down in a straight manner from respective inner ends of the upper right face portion 43R and the upper left face portion 43L. As illustrated in FIGS. 2, 3, the right tip end portion 44R and the left tip end portion 44L are provided with a plurality of locking grooves 46 disposed adjacently along a slide direction, extending in an up-down direction, and being opened on end sides thereof.

As illustrated in FIG. 2, the upper rail 20 is disposed on the seat-body-1 side (see FIG. 1), and is fitted to the lower rail 40 so as to be movable in a sliding manner in the rail longitudinal direction thereof. As illustrated in FIG. 5, the upper rail 20 is formed integrally to have the following cross section shape by bending, in several places, a single flat-plate member made of a ferrous material. More specifically, the upper rail 20 includes an upper face portion 21 having a flat-plate shape and facing the floor surface F generally in a parallel manner. The upper face portion 21 includes a flat-plate right side face portion 42R and a flat-plate left side face portion 42L hanging down in a straight manner from respective ends of the upper face portion 21. The right side face portion 22R and the left side face portion 22L respectively include right folded face portion 23R and a left folded face portion 23L obtained by folding outwardly lower ends of the right side face portion 22R and the left side face portion 22L in a curved manner. The right folded face portion 23R and the left folded face portion 23L respectively include a right tip end portion 24R and a left tip end portion 24L rising in a bending manner from respective outer ends of the right folded face portion 23R and the left folded face portion 23L. As illustrated in FIGS. 2, 3, the right tip end portion 24R and the left tip end portion 24L of the upper rail 20 have respective notch portions 25 formed by partially cutting the right tip end portion 24R and the left tip end portion 24L so as to correspond to the locking grooves 46 of the lower rail 40 in the slide direction. The right side face portion 22R and the left side face portion 22L correspond to “a pair of side face portions” in the present invention.

Hereby, as illustrated in FIG. 5, the lower rail 40 and the upper rail 20 are configured such that, in a sectional view perpendicular to the longitudinal direction thereof, the upper rail 20 is inserted into the lower rail 40 so that the right tip end portion 44R of the lower rail 40 overlaps with the right tip end portion 24R of the upper rail 20, and the left tip end portion 44L of the lower rail 40 overlaps with the left tip end portion 24L of the upper rail 20 in a direction perpendicular to the longitudinal direction thereof. This accordingly constitutes a fitting portion 12 for preventing separation between the lower rail 40 and the upper rail 20.

The slide lock mechanism 70 is a mechanism capable of regulating a slide movement of the slide rail 11 in an appropriate position in the vehicle front-rear direction, as illustrated in FIG. 2. The slide lock mechanism 70 is mainly constituted by a lock spring 80 (a locking member, and a first biasing member), and an operating member 90.

As illustrated in FIG. 2, the lock spring 80 (the locking member, the first biasing member) is a member having a function as the locking member to cause a slide lock state by engaging the locking groove 46 with the notch portion 25 to regulate a slide movement of the upper rail 20 relative to the lower rail 40 in an appropriate position, and a function as the first biasing member to maintain such a slide lock state by elastic bias. The lock spring 80 is constituted by a metal linear member 89 having a uniform section. As illustrated in FIGS. 2, 3, the lock spring 80 is constituted by a generally U-shaped elongated member configured such that a first linear portion 81 disposed in a direction intersecting with the slide rail 11 is integrally connected to a second linear portion 82 and a third linear portion 83 extending from respective ends of the first linear portion 81 toward one side in the, slide direction of the slide rail 11. The second linear portion 82 and the third linear portion 83 are each provided with an elastically deformable portion 84 that is elastically deformable in an up-down direction and disposed at an intermediate position in a longitudinal direction thereof. The elastically deformable portion 84 is provided with engagement portions 85 that are each engageable and disengageable with the locking groove 46 and the notch portion 25. The engagement portions 85 are formed such that the second linear portion 82 and the third linear portion 83 are bent repeatedly in a width direction (generally parallel to the first linear portion 81) intersecting with the slide direction of the slide rail 11, and thus, the engagement portions 85 are formed in a lattice shape in which the locking groove 46 and the notch portion 25 are receivable. The lock spring 80 includes a spring latching portion 82A formed in an end of the second linear portion 82, and a spring latching portion 83A formed in an end of the third linear portion 83.

The lock spring 80 is provided inside the slide rail 11 in a biasing state as illustrated in FIG. 3. More specifically, the upper rail 20 includes front support portions 26A and rear support portions 26B formed by partially cutting and raising the right side face portion 22R and the left side face portion 22L. The spring latching portion 82A and the spring latching portion 83A of the lock spring 80 are locked from above by a locking portion 92F of the after-mentioned lever member 92. Further, those parts of the second linear portion 82 and third linear portion 83 which are respectively placed between the elastically deformable portion 84 and the spring latching portion 82A and between the elastically deformable portion 84 and the spring latching portion 83A in the lock spring 80 are supported by the front support portions 26A from below. Further, the first linear portion 81 of the lock spring 80 is supported by the rear support portions 26B from below.

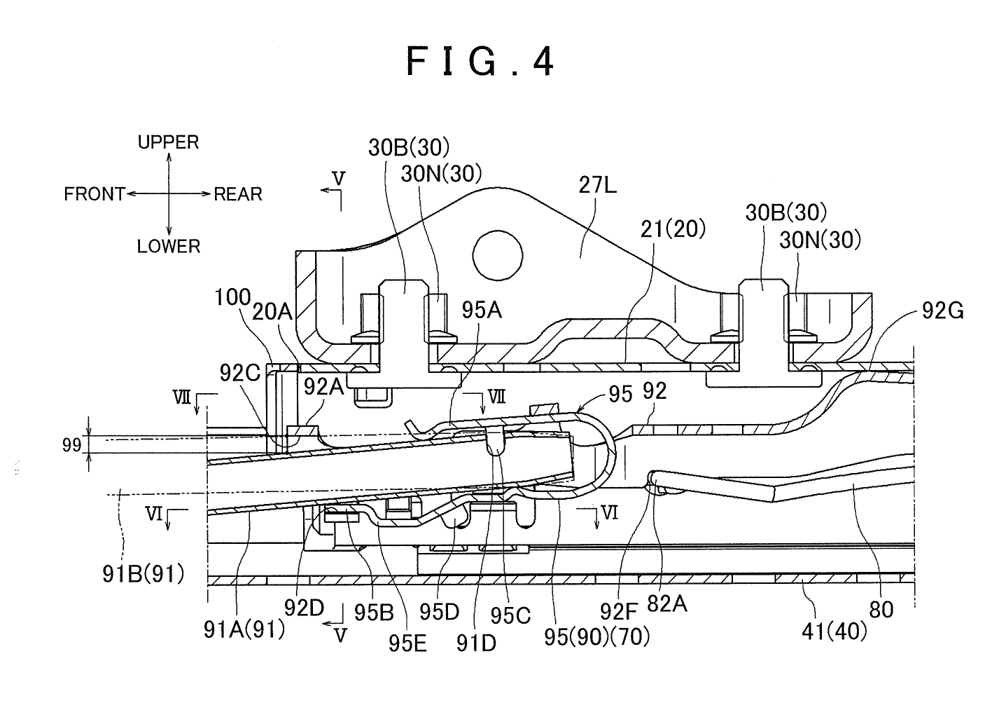

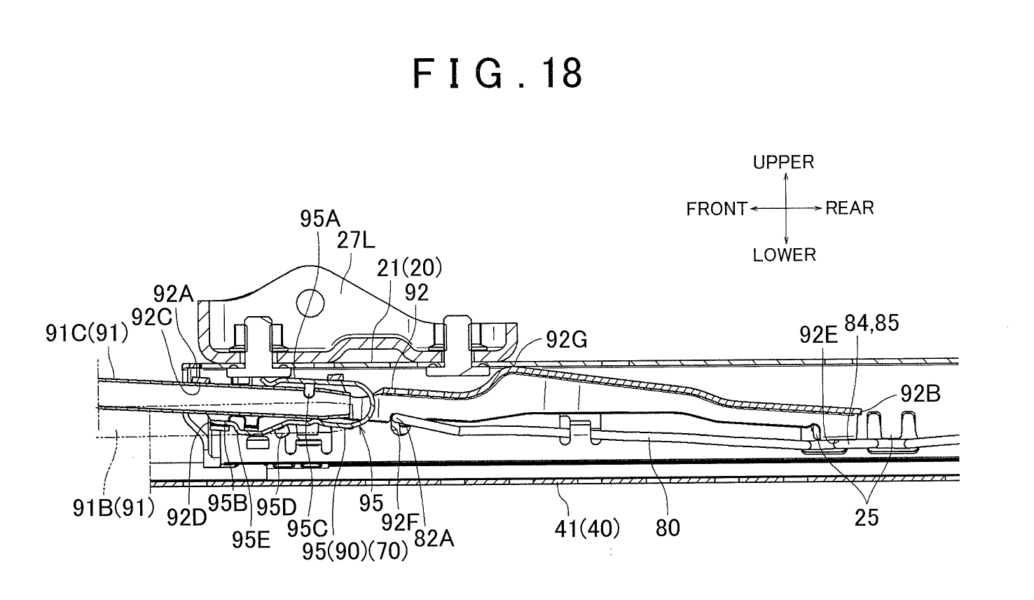

As illustrated in FIGS. 2, 3, the operating member 90 is a member that transmits a release control force of an operator to the lock spring 80, in order to release the slide lock state where the lock spring 80 serving as the locking member is engaged with the locking grooves 46 and the notch portions 25. The operating member 90 is mainly constituted by a loop handle 91 (an operation input member), a lever member 92 (an operation output member), and a leaf spring 95 (a second biasing member). The loop handle 91 is a member that inputs the release control force to release the slide lock state of the lock spring 80 in the slide lock mechanism 70. The lever member 92 is a member that outputs the release control force of the loop handle 91 and to transmit it to the lock spring 80. The lever member 92 is a member that operates the engagement portions 85 to be engaged and disengaged with the locking grooves 46 and the notch portions 25 by pressing the elastically deformable portions 84 of the lock spring 80 provided inside the slide rail 11 so as to elastically deform the elastically deformable portions 84 in the up-down direction. The lever member 92 is configured as an elongated member by bending a metal plate-like member. As illustrated in FIGS. 3, 5, the lever member 92 is provided inside a space 13 formed between the upper face portion 21 of the upper rail 20 and the lower face portion 41 of the lower rail 40 and also between the right side face portion 22R and the left side face portion 22L of the upper rail 20 (see FIG. 5). The after-mentioned loop handle 91 is inserted into a front-end-92A side of the lever member 92, as illustrated in FIGS. 3, 4. A pressing portion 92E that presses the elastically deformable portions 84 of the lock spring 80 is provided on an rear-end-92B side of the lever member 92, as illustrated in FIG. 3. A top surface of the lever member 92 in an intermediate position in a longitudinal direction thereof partially projects so as to constitute a supporting point 92G that abuts with the upper face portion 21 of the upper rail 20. Further, the locking portion 92F that locks the spring latching portion 82A and the spring latching portion 83A (see FIG. 2) of the lock spring 80 is provided between the front end 92A and the supporting point 92G of the lever member 92. The loop handle 91 is inserted into those lever members 92 placed in the upper rails 20 of the right and left slide rails 11 which are each formed by appropriately bending a metallic bar-shaped member. As illustrated in FIGS. 2 to 4 and FIGS. 15 to 18, the leaf spring 95 is a metallic plate-like member having a generally U-shaped section. The leaf spring 95 is disposed on a front-end-92A side of the lever member 92. An end of the loop handle 91 is inserted into an open-end side of the leaf spring 95. One end 95A of the leaf spring 95 is provided with a projection 95C. The projection 95C is engaged with an upper opening 91D of the loop handle 91 and holds the loop handle 91 so that the loop handle 91 does not fall out. Further, the one end 95A of the leaf spring 95 abuts with the loop handle 91 so as to bias the loop handle 91 downward. The other end 95B of the leaf spring 95 has a stepped portion 95E having a tip end bending in a plate-thickness direction so as to be abuttable with a rear side of the stopper 92D. Thus, the leaf spring 95 is held so as not to fall out of the lever member 92 toward a front side. Further, the other end 95B of the leaf spring 95 is provided with projections 95D. The projections 95D are engaged with respective parts formed by partially cutting and raising the right side face portion 22R and the left side face portion 22L of the upper rail 20, so that the leaf spring 95 and the lever member 92 are held so as not to move toward a rear side. Note that, when a biasing force of the lock spring 80 is compared with that of the leaf spring 95, the biasing force of the lock spring 80 is set larger than that of the leaf spring 95. The front end 92A of the lever member 92 is provided with: a stopper 92C with which an upper part of an outer peripheral surface of the loop handle 91 abuts; and a stopper 92D with which a lower part of the outer peripheral surface of the loop handle 91 abuts via the other end 95B of the leaf spring 95. Hereby, the loop handle 91 is attached (connected) to the lever member 92 with the leaf spring 95 being placed therebetween, so that the loop handle 91 is rotatable (movable) relative to the lever member 92 in a vehicle up-down direction between an initial position 91A in which the loop handle 91 abuts with the stopper 92D due to the biasing force of the leaf spring 95, and a first operation position 91B in which the loop handle 91 abuts with the stopper 92C due to an operation force of the operator against the biasing force of the leaf spring 95. The loop handle 91 is biased by the leaf spring 95 so as to be generally placed in the initial position 91A as illustrated in FIG. 4. A clearance 99 (play) that allows relative rotation (movement) between the loop handle 91 and the lever member 92 is provided between the upper part of the outer peripheral surface of the loop handle 91 in the initial position 91A and the stopper 92C of the lever member 92. When an operation force is applied to the loop handle 91 in a direction where the loop handle 91 is lifted upward, the loop handle 91 rotates in a clockwise direction in FIG. 4 until the loop handle 91 abuts with the stopper 92C against the biasing force of the leaf spring 95 (the loop handle 91 pivots within the clearance 99). When the loop handle 91 is further operated from the first operation position 91B in which the loop handle 91 abuts with the stopper 92C of the lever member 92 as illustrated in FIG. 17, the front-end-92A side is lifted. At this time, while the loop handle 91 abuts with the stopper 92C, the biasing force of the leaf spring 95 is not further applied thereto (the biasing force does not increase). In such a state, the lever member 92 rotates in a clockwise direction in FIG. 17 around the supporting point 92G, so as to reach a second operation position 91C in which the pressing portion 92E (see FIG. 3) moves downward against the biasing force of the lock spring 80. The pressing portion 92E (see FIG. 3) of the lever member 92 placed in the second operation position 91C presses the elastically deformable portion 84 of the lock spring 80 so as to elastically deform the elastically deformable portion 84 as illustrated in FIG. 18, thereby disengaging the engagement portions 85 from the locking grooves 46 and the notch portions 25 (see FIGS. 2, 3).

In the present embodiment, the other end 95B of the leaf spring 95 employs a configuration in which the stepped portion 95E abuts with the stopper 92D, and a configuration in which the projections 95D are engaged with the respective parts formed by partially cutting and raising the right side face portion 22R and the left side face portion 22L of the upper rail 20. Various attachment configurations of the leaf spring 95 can be employed. For example, the other end 95B of the leaf spring 95 may be configured to be inserted into parts formed by partially cutting and raising the right side face portion 22R and the left side face portion 22L of the upper rail 20. However, in such a configuration, the biasing force of the leaf spring 95 is applied even when the loop handle 91 moves from the first operation position 91B to the second operation position 91C. In view of this, an unnecessarily larger release control force to be applied to the loop handle 91 is required just by the biasing force of the leaf spring 95. This makes it hard to obtain a continuous operation sense of the release control force. However, in the present embodiment, while the loop handle 91 moves from the first operation position 91B to the second operation position 91C (while it abuts with the stopper 92C), the biasing force of the leaf spring 95 is not further applied thereto (the biasing force does not increase). On that account, while the loop handle 91 moves from the initial position 91A to the first operation position 91B, the biasing force of the leaf spring 95 (the second biasing member) is applied thereto, and while the loop handle 91 moves from the first operation position 91B to the second operation position 91C, the biasing force of the lock spring 80 (the first biasing member) is applied thereto. Hereby, it is possible to obtain a continuous lock-releasing operation sense as the release control force. That is, when the loop handle 91 is moved from the initial position 91A to the first operation position 91B, a lock release force is transmitted to the lever member 92 via the leaf spring 95 (the second biasing member) (against the biasing force of the leaf spring 95). Then, when the loop handle 91 is moved from the first operation position 91B to the second operation position 91C, the lock release force is transmitted to the lever member 92 against the biasing force of the lock spring 80. This realizes a continuous lock-releasing feeling.

As illustrated in FIGS. 1, 2, a link mechanism 50 is provided between the cushion frame 3f of the seat body 1 and the slide rail device 10 in the car seat. The link mechanism 50 is constituted by the front rod 51, the rear rod 52, front links 53R, 53L, and rear links 54R, 54L. The front links 53R, 53L each constituted by a board member made of a ferrous material are integrally fixed to both ends of the front rod 51. Similarly, the rear links 54R, 54L each constituted by a board member made of a ferrous material are integrally fixed to both ends of the rear rod 52. The front links 53R, 53L at both ends of the front rod 51 are rotatably attached thereto via brackets 27R, 27L, respectively. The bracket 27R, 27L is attached to the upper face portion 21 of the upper rail 20 by a fastening member 30 constituted by bolts 30B and nuts 30N so as to sandwich a pivot shaft of the front link 53R, 53L in the front-rear direction. Similarly, the rear links 54R, 54L at both ends of the rear rod 52 are rotatably attached to link pivot shafts 29R, 29L via brackets 28R, 28L, respectively. The bracket 28R, 28L is attached to the upper face portion 21 of the upper rail 20 by a fastening member 30 constituted by bolts 30B and nuts 30N so as to sandwich a link pivot shaft 29R, 29L of the rear link 54R, 54L in the front-rear direction. Pivoting of each link in the link mechanism 50 is performed by an operation of a lift mechanism 60.

In a case where the lift mechanism 60 is provided on a front seat on the left side, as illustrated in FIG. 1, for example, the lift mechanism 60 is disposed on an outer side of the seat cushion 3 (the left side in FIG. 1 in a state where a sitting person sits thereon). The lift mechanism 60 is mainly constituted by a pinion gear (not shown), an operating pivot member 62, a lifter lever 64, a sector gear (not shown). The lift mechanism 60 is configured such that the operating pivot member 62 and the lifter lever 64 are disposed on an outer side of the lower arm 5, and the pinion gear and the sector gear (not shown) are disposed on an inner side of the lower arm 5. The sector gear is integrally fixed to the rear rod 52, and the pinion gear is engaged therewith. The pinion gear is connected to the operating pivot member 62 via a hole portion (not shown) formed in the lower arm 5, and the operating pivot member 62 is connected to the lifter lever 64.

As illustrated in FIG. 1, when a rotation operating force is applied to the lifter lever 64, the pinion gear rotates, so that the rotation operating force is transmitted to the sector gear and the rear rod 52 pivots. Along with the pivot of the rear rod 52 in one direction, the rear link 54R and the rear link 54L pivot around the link pivot shafts 29R, 29L of the brackets 28R, 28L toward a front side in FIG. 1 (i.e., in a counterclockwise direction in FIG. 1). Hereby, the seat body 1 moves to an upward movement position that is a front side and an upper side. When a rotation operating force is applied to the lifter lever 64 and the pinion gear rotates reversely, the rear rod 52 pivots in a reverse direction. Along with the pivot of the rear rod 52 in the other direction, the rear link 54R and the rear link 54L pivot around the link pivot shafts 29R, 29L of the brackets 28R, 28L toward a rear side in FIG. 1 (i.e., in a clockwise direction in FIG. 1). Hereby, the seat body 1 moves to a downward movement position that is a rear side and a downward side. The front rod 51 and the front links 53R, 53L pivot in the same direction along with the movement of the seat body 1. Note that, when the rotation operating force is not applied to the lifter lever 64, a braking force of the operating pivot member 62 works in the lift mechanism 60, so that a rotation of the pinion gear is restricted. Accordingly, the pivot of the rear rod 52 is restricted, so as to retain a position of the seat body 1 in the up-down direction.

The upper rail 20 and the lower rail 40 in the slide rail 11 are provided with caps 100, 150 and caps 200, 250, respectively, so as to protect respective ends thereof, as illustrated in FIG. 2. The caps 100, 150, 200, 250 are made of synthetic resin, and are fitted into their corresponding rail ends. Further, the caps 100, 150 provided in the upper rail 20 are configured to prevent deformation of the ends of the upper rail 20.

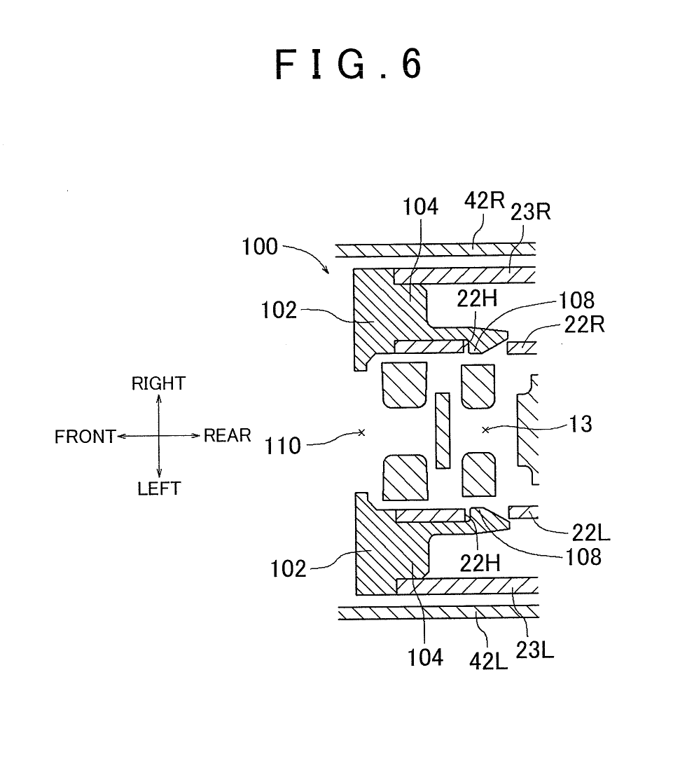

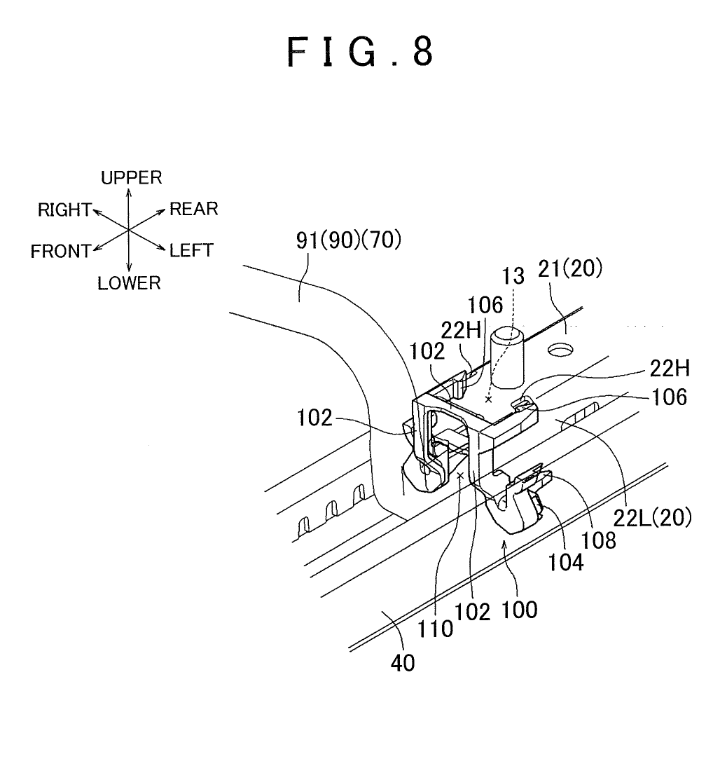

The cap 100 is provided in a vehicle-front-side end out of longitudinal ends of the upper rail 20, as illustrated in FIGS. 6 to 9. The cap 100 includes a base portion 102 adjacent to the upper rail 20 generally along a shape of an end surface of the upper rail 20. In a sectional view of the cap 100 viewed in a direction perpendicular to the longitudinal direction of the lower rail 40 and the upper rail 20, space filling portions 104 that fill spaces in the fitting portion 12 in a separation direction where the lower rail 40 and the upper rail 20 are separated from each other are formed in the cap 100 so as to extend from the base portion 102 toward a longitudinal center of the upper rail 20. In the spaces in the fitting portion 12 in the separation direction where the lower rail 40 and the upper rail 20 are separated from each other, the space filling portions 104 are provided in spaces opposed to the right tip end portion 44R and the left tip end portion 44L. More specifically, the space filling portions 104 are each formed in a shape that fills a space between the right tip end portion 44R of the lower rail 40 and the right folded face portion 23R of the upper rail 20, or a space between the left tip end portion 44L of the lower rail 40 and the left folded face portion 23L of the upper rail 20. The cap 100 includes claw portions locked to hole portions 22H provided in the right side face portion 22R and the left side face portion 22L (see FIG. 8) of the upper rail 20 so as to be attached thereto. The claw portions include: a pair of first claw portions 106 provided on an upper side; and a pair of second claw portions 108 provided on a lower side. The pair of first claw portions 106 and the pair of second claw portions 108 extend from the base portion 102 toward the longitudinal center of the upper rail 20. The first claw portions 106 and the second claw portions 108 of the cap 100 are configured to be locked, from outside, to the hole portions 22H of the right side face portion 22R and the left side face portion 22L (see FIG. 8) of the upper rail 20. The base portion 102 of the cap 100 is provided with an opened portion 110 that allows the operating member 90 to be inserted therefrom into the space 13 of the slide rail 11. The hole portions 22H to which the first claw portions 106 and the second claw portions 108 are locked may be formed in the upper face portion 21 of the upper rail 20.

As such, the cap 100 includes the base portion 102 adjacent to the upper rail 20 generally along a shape of an end surface of a longitudinal end of the upper rail 20 in which the cap 100 is provided. This allows the base portion 102 of the cap 100 to protect the end of the upper rail 20. Further, the cap 100 includes the space filling portions 104 formed so as to extend from the base portion 102 toward the longitudinal center of the upper rail 20 in which the cap 100 is provided, so as to fill the spaces in the fitting portion 12 in the separation direction where the lower rail 40 and the upper rail 20 are separated from each other. Accordingly, when a large load caused due to a vehicle collision or the like is applied in the direction where the lower rail 40 and the upper rail 20 are separated from each other, the space filling portions 104 of the cap 100 restrain backlash between these members (relative movement therebetween in the up-down direction), thereby making it possible to improve rigidity of the rails. Due to the improvement of the rigidity of the rails, it is possible to prevent deformation of the ends of the lower rail 40 and the upper rail 20. In this way, it is possible to protect the rail end of the upper rail 20 and also to prevent deformation of the ends of the lower rail 40 and the upper rail 20.

Further, in the spaces in the fitting portion 12 in the separation direction where the lower rail 40 and the upper rail 20 are separated from each other, the space filling portions 104 are provided in the spaces opposed to the right tip end portion 44R and the left tip end portion 44L (a pair of inner tip end portions). This is because, when a large load caused due to a vehicle collision or the like is applied in the direction where the lower rail 40 and the upper rail 20 are separated from each other, backlash between these members occurs markedly in the right tip end portion 44R and in the left tip end portion 44L. In view of this, by providing the space filling portions 104 in such portions, it is possible to further prevent deformation of the ends of the lower rail 40 and the upper rail 20 and to improve the rigidity thereof.

Further, the cap 100 is attached to the upper rail 20 by locking with the first claw portions 106 and the second claw portions 108. The attachment of the cap 100 does not need to perform fixation by use of a fastening member or the like. This may allow the cap 100 to achieve reduction of the number of component parts and improvement of attachment workability.

Further, the first claw portions 106 and the second claw portions 108 used for the attachment of the cap 100 are configured to be locked, from outside, to the hole portions 22H formed at least one of the side surface potions of the upper rail 20. This makes it possible to restrain interference of slide movements of the lower rail 40 and the upper rail 20.

Further, the lock spring 80 (the locking member) is disposed in the space 13 formed between the lower face portion 41 of the lower rail 40 and the upper face portion 21 of the upper rail 20, and the operating member 90 is configured to be inserted from longitudinal ends of the lower rail 40 and the upper rail 20 so as to be engaged with the lock spring 80. As such, the slide lock mechanism 70 is disposed within the slide rail 11, so that it is possible to realize effective utilization of a space around the slide rail 11. However, in a case of such a configuration, the operating member 90 is inserted from a longitudinal end of the slide rail 11, which may cause such a concern that the operating member 90 interferes with the cap 100. However, the base portion 102 of the cap 100 is provided with the opened portion 110 that allows the insertion of the operating member 90. Since the base portion 102 of the cap 100 includes the opened portion 110, even if the operating member 90 for operating the lock spring 80 disposed within the slide rail 11 is inserted from the longitudinal end of the slide rail 11, it is possible to protect the rail end of the upper rail 20 and also to prevent deformation of the end of the upper rail 20.

The above description deals with a configuration in which the cap 100 is provided in the front end 20A of the upper rail 20, but this configuration is also applicable to the rear end 20B. Further, the above description deals with a configuration in which the space filling portions 104 of the cap 100 are provided in the upper rail 20, but the space filling portions 104 may be provided in the front end 40A or the rear end 40B of the lower rail 40. Further, the above description deals with a configuration in which in the spaces in the separation direction, the space filling portions 104 are provided in the spaces opposed to the right tip end portion 44R and the left tip end portion 44L of the lower rail 40. However, it is possible to provide the space filling portions 104 in various parts in the fitting portion 12 for preventing separation between the lower rail 40 and the upper rail 20, provided that a space in the separation direction of these members can be filled in those parts.

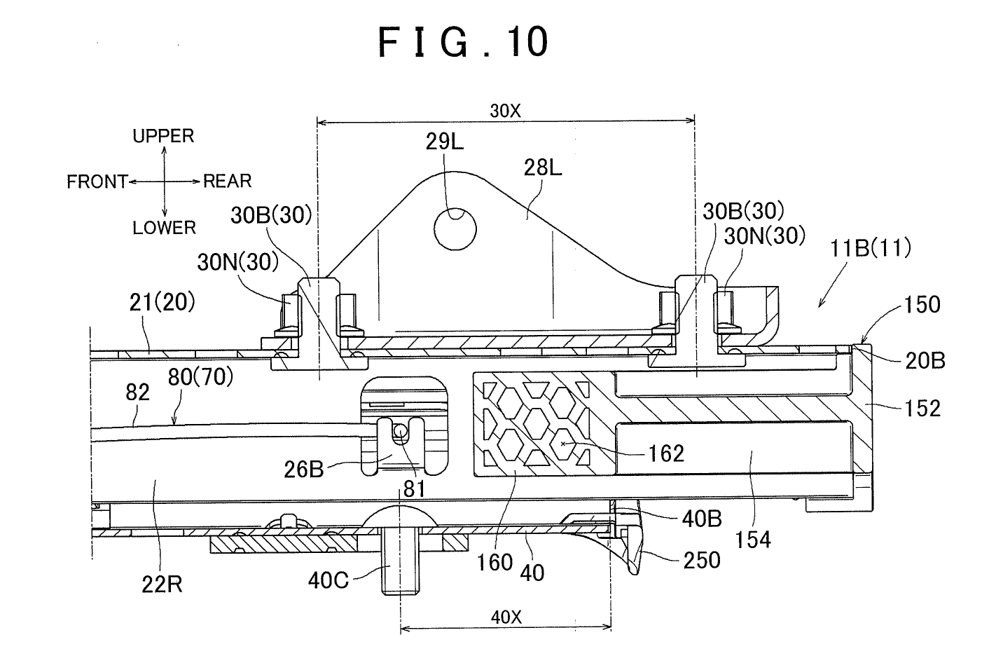

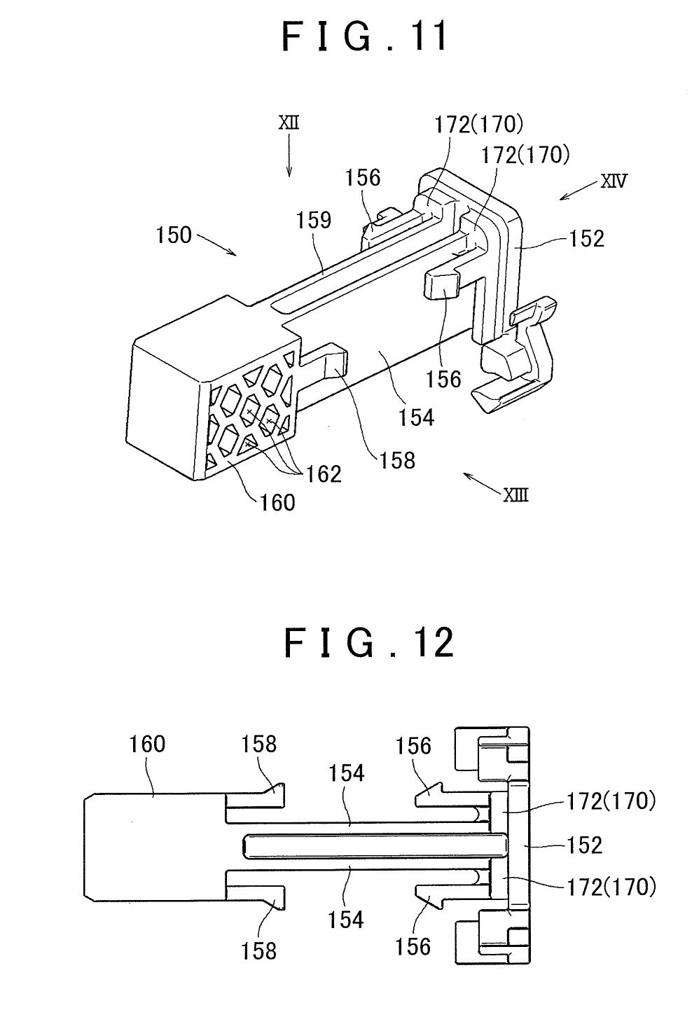

As illustrated in FIGS. 10 to 14, the cap 150 is provided in the rear end 20B of the upper rail 20 so as to protect the rear end 20B of the upper rail 20 and to restrain deformation of the upper rail 20, thereby restraining separation thereof from the lower rail 40. The cap 150 includes a flat-plate base portion 152 adjacent to the longitudinal rear end 20B of the upper rail 20 in which the cap 150 is provided. As illustrated in FIG. 14, in order to protect the rear end 20B of the upper rail 20, the base portion 152 is formed to have a shape similar to the shape of the space 13 (see FIG. 5), and the right tip end portion 24R and the left tip end portion 24L (see FIG. 5). Further, as illustrated in FIG. 10, the cap 150 includes: a first deformation prevention portion 160 provided so as to extend into the space 13 from the base portion 152 toward the longitudinal center of the upper rail 20 and to be placed between the right side face portion 22R and the left side face portion 22L (see FIG. 5) within the space 13, thereby restraining deformation of the rail. The first deformation prevention portion 160 is formed in a cubic shape so as to face the upper face portion 21, the right side face portion 22R, and the left side face portion 22L within the space 13. Those parts of the first deformation prevention portion 160 which face the right side face portion 22R and the left side face portion 22L have a plurality of penetration portions 162 opened so as to penetrate between the right side face portion 22R and the left side face portion 22L. This allows the first deformation prevention portion 160 to reduce its weight without reducing its rigidity. Further, the cap 150 includes claw portions attached to the upper rail 20 by being locked to hole portions 22H (see FIG. 2) provided in the right side face portion 22R and the left side face portion 22L (see FIG. 5) of the rear end 20B of the upper rail 20. The claw portions are provided between the base portion 152 and the first deformation prevention portion 160 in the cap 150 as illustrated in FIGS. 11, 12, and include: a pair of first claw portions 156 provided on a base-portion-152 side; and a pair of second claw portions 158 provided on a first-deformation-prevention-portion-160 side. Here, as illustrated in FIG. 10, when the upper rail 20 is placed in a rearmost position 11B within a slidable range where the upper rail 20 is movable in a sliding manner relative to the lower rail 40, the slide rail 11 has a positional relationship in which the rear end 20B of the upper rail 20 is placed on a rear side relative to the rear end 40B of the lower rail 40. Therefore, at the time of the positional relationship in which the upper rail 20 is placed in the rearmost position 11B within the slidable range, the first deformation prevention portion 160 is provided in vicinity to the rear end 40B of the lower rail 40. More specifically, at the time of the positional relationship in which the upper rail 20 is placed in the rearmost position 11B within the slidable range, the first deformation prevention portion 160 is disposed so as to longitudinally overlap with at least part of a fixing area 40X between the rear end 40B of the lower rail 40 and a fixing member 40C fixing a rear-end-40B side of the lower rail 40 to a vehicle component such as a floor of the vehicle. Further, the first deformation prevention portion 160 is disposed so as to longitudinally overlap with at least part of an attachment area 30X where the seat body 1 is attached to the upper face portion 21 of the upper rail 20 by a fastening member 30 constituted by bolts 30B and nuts 30N. In view of this, the cap 150 is provided with a connection portion 154 for integrally connecting the base portion 152 to the first deformation prevention portion 160 so as to provide, away from the base portion 152, the first deformation prevention portion 160 in a position corresponding to the areas 40X, 30X. As illustrated in FIGS. 11, 12, the connection portion 154 is formed thinner than the base portion 152 and the first deformation prevention portion 160, so as to achieve reduction in weight and to allow the first claw portions 156 and the second claw portions 158 to be easily deformed elastically. Further, the base portion 152 is provided with a second deformation prevention portion 170 restraining deformation of the lower rail 40 or the longitudinal rear end 20B of the upper rail 20. In a position of the rear end 20B of the upper rail 20, the second deformation prevention portion 170 is provided with wall portions 172 that abut with an inner peripheral surface of the upper face portion 21 and inner peripheral surfaces of the right side face portion 22R and the left side face portion 22L.

As such, according to the vehicle seat of the embodiment, the cap 150 includes the base portion 152 adjacent to the longitudinal rear end 20B of the upper rail 20 in which the cap 150 is provided, thereby making it possible to protect the rail end. Further, the first deformation prevention portion 160 is provided between the right side face portion 22R and the left side face portion 22L within the space 13 surrounded by the lower face portion 41 of the lower rail 40, the upper face portion 21 of the upper rail 20, and the right side face portion 22R and the left side face portion 22L (a pair of side face portions) of the upper rail 20. Here, when a large load is applied to the slide rail 11 due to a vehicle collision or the like so that the seat body 1 falls forward and the lower rail 40 and the upper rail 20 move away from the rear side due to the large load, the right side face portion 22R and the left side face portion 22L are deformed so as to come close to each other. In view of this, the first deformation prevention portion 160 restrains the deformation of the right side face portion 22R and the left side face portion 22L, so as to restrain deformation of the rail. Further, the base portion 152 and the first deformation prevention portion 160 are provided integrally, thereby making it possible to restrain the number of components. Further, when the upper rail 20 is placed in the rearmost position 11B within the slidable range where the upper rail 20 is movable in a sliding manner relative to the lower rail 40, the slide rail 11 has the positional relationship in which the rear end 20B of the upper rail 20 is placed on a rear side relative to the rear end 40B of the lower rail 40. At this time, if the lower rail 40 and the upper rail 20 move away from the rear side due to the vehicle collision or the like, the rear end 40B of the lower rail 40 is deformed markedly. In terms of this, at the time of the positional relationship in which the upper rail 20 is placed in the rearmost position 11B within the slidable range, the first deformation prevention portion 160 is provided in vicinity to the rear end 40B of the lower rail 40. As such, the first deformation prevention portion 160 is disposed in a desirable position in terms of restraining deformation of the rail.

Further, at the time of the positional relationship in which the upper rail 20 is placed in the rearmost position 11B within the slidable range, the first deformation prevention portion 160 is disposed so as to longitudinally overlap with at least part of the fixing area 40X between the rear end 40B of the lower rail 40 and the fixing member 40C fixing the rear-end-40B side of the lower rail 40 to the vehicle component such as the floor of the vehicle. Accordingly, the first deformation prevention portion 160 is disposed in a further desirable position in terms of restraining the deformation of the rail.

Further, the first deformation prevention portion 160 is disposed so as to longitudinally overlap with at least part of the attachment area 30X where the seat body 1 is attached to the upper face portion 21 of the upper rail 20. At the time when a large load is applied to the slide rail 11 due to a vehicle collision or the like so that the seat body 1 falls forward, a transmission path of the load is the attachment area 30X where the seat body 1 is attached to the upper face portion 21 of the upper rail 20. Accordingly, when the first deformation prevention portion 160 is disposed in the attachment area 30X serving as an origin of the deformation, it is further possible to restrain the deformation of the rail.

Further, when the base portion 152 of the cap 150 is provided with the second deformation prevention portion 170 restraining deformation of the lower rail 40 or the longitudinal rear end 20B of the upper rail 20, it is further possible to restrain the deformation of the rail.

The configurations of the lower rail 40 and the upper rail 20 of the slide rail 11 are just one example of one embodiment, and various rail configurations are usable provided that the fitting portion 12 for preventing separation between the lower rail 40 and the upper rail 20 can be provided therein. For example, the lower rail 40 and the upper rail 20 may be configured in a reverse manner to the present embodiment. Further, the caps 100, 150, 200, 250 exemplified herein are made of synthetic resin, but the caps are not limited to this, and may be made of metal. Further, the lift mechanism 60 is not a necessary constituent in the vehicle seat. That is, the seat body 1 may be connected to the upper rail 20 via a bracket without the lift mechanism 60.

As such, according to the vehicle seat of the embodiment, the clearance 99 is set in the operating member 90 between the initial position 91A and the second operation position 91C in which the slide lock state by the lock spring 80 is released by the release control force against the biasing faces of the lock spring 80 (the locking member, the first biasing member) and of the leaf spring 95 (the second biasing member). Accordingly, even in a case where an unexpected external load such as a large load is applied to the slide lock mechanism 70 and the slide rail 11, it is possible to restrain unintended release of slide lock. Further, the operating member 90 includes the leaf spring 95 (the second biasing member) that biases the loop handle 91 to the initial position 91A in which the operation of the operating member 90 is not started. This makes it possible to stably hold the loop handle 91 in the initial position 91A until the release control force is applied to the operating member 90.

Further, the operating member 90 is constituted by two components: the loop handle 91 (an operation input member) that inputs a release control force; and the lever member 92 (an operation output member) that outputs the release control force. Further, the clearance 99 is provided between the loop handle 91 and the lever member 92. The initial position 91A is set by retaining the clearance 99 between the loop handle 91 and the lever member 92 by biasing the loop handle 91 by the leaf spring 95 (the second biasing member). This attains the slide lock mechanism 70 that more stably restrains unintended release of slide lock.

Further, it is possible to obtain a continuous operation sense of the operating member 90 without increasing the release control force to be applied to the operating member 90 more than required.

Further, the lock spring 80 is disposed in the space 13 of the slide rail 11. This makes it possible to form the slide lock mechanism 70 in a compact shape, thereby making it possible to effectively use a space around the seat body 1. Further, even in such a compact slide lock mechanism 70, it is possible to restrain unintended release of slide lock.

The embodiment of the invention has been described above, but the vehicle seat of the present invention is not limited to the above embodiment, and is performable in various embodiments other than the above embodiment. The above description deals with a configuration in which the locking member and the operating member are both placed in the slide rail, but the present invention is not limited to this. For example, the locking member and the operating member may be provided outside the slide rail. The above description deals with a configuration in which the loop handle (the operation input member) is formed separately from the lever member (the operation output member), but the present invention is not limited to this. For example, the operation input member and the operation output member may be formed integrally. The above description deals with a configuration in which the lock spring has a function as the locking member and a function as the first biasing member, but the present invention is not limited to this. For example, the slide lock mechanism may be configured such that the lock member is formed separately from the first biasing member.

What is claimed is:

1. A vehicle seat comprising:
a slide rail including a lower rail disposed on a vehicle component side, and an upper rail disposed on a seat body side and supported by the lower rail so as to be movable in a sliding manner; and
a slide lock mechanism that regulates a slide movement of the upper rail relative to the lower rail in an appropriate position, wherein:
the slide lock mechanism includes a locking member that regulates the slide movement of the upper rail in the appropriate position as a slide lock state, and an operating member that transmits, to the locking member, a release control force to release the slide lock state of the locking member;
the locking member includes a first biasing member that maintains the slide lock state of the locking member in an elastically biasing manner;
the operating member includes a second biasing member to bias the operating member to an initial position in which an operation of the operating member is not started;
when a biasing force of the first biasing member is compared with that of the second biasing member, the biasing force of the first biasing member is set larger than that of the second biasing member;
a clearance is set for the operating member between the initial position and an operation position in which the release control force is applied thereto against the biasing forces of the first biasing member and the second biasing member so that the slide lock state of the locking member is released;
the operating member includes an operation input member that inputs the release control force, and an operation output member that outputs the release control force;
the second biasing member is provided between the operation input member and the operation output member so that the operation input member is connected to the operation output member so as to be movable relative to each other;
the clearance is provided between the operation input member and the operation output member; and
the initial position is set by retaining the clearance between the operation input member and the operation output member by the second biasing member.

2. The vehicle seat according to claim 1, wherein:
between the initial position and the operation position to which the operating member moves upon reception of the release control force, the following operation positions are set: a first operation position in which the operation input member moving from the initial position within the clearance against the biasing force of the second biasing member is engaged with the operation output member; and a second operation position in which the operation input member and the operation output member moving from the first operation position in an integrated manner against the biasing force of the first biasing member release the slide lock state of the locking member, and
the operating member is configured such that the operation input member and the operation output member move to the second operation position against the biasing force of the first biasing member in a state where the biasing force of the second biasing member with respect to the operation input member placed in the first operation position does not increase.

3. The vehicle seat according to claim 1, wherein:
the lock member is disposed in a space surrounded by a lower face portion of the lower rail which faces the vehicle component side, a upper face portion of the upper rail which faces the seat body side, and a pair of side face portions of the lower rail or the upper rail; and
the operating member is inserted from longitudinal ends of the lower rail and the upper rail so as to be engaged with the locking member.
